(19) United States
(12) Patent Application Publication
(10) Pub. No.: US 2006/0236753 A1
(43) Pub. Date: Oct. 26, 2006

(54) Internal combustion engine knock determination device

(75) Inventors: Masatomo Yoshihara, Toyota-shi (JP); Kenji Kasashima, Nishikamo-gun (JP); Rihito Kaneko, Nishikamo-gun (JP); Koji Aso, Susono-shi (JP); Kenji Senda, Okazaki-shi (JP); Yuichi Takemura, Anjo-shi (JP); Kiyoshi Iwade, Okazaki-shi (JP); Shuhei Oe, Kariya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignees: TOYOTA JIDOSHA KABUSHIKI KAISHA, Toyota-shi (JP); DENSO CORPORATION, Kariya-shi (JP); NIPPON SOKEN, INC., Nishio-shi (JP)

(21) Appl. No.: 11/409,079

(22) Filed: Apr. 24, 2006

(30) Foreign Application Priority Data
Apr. 25, 2005 (JP) 2005-126886

(51) Int. Cl. G01L 23/22; G06G 7/70; G01M 15/00

(52) U.S. Cl. 73/35.09; 73/116; 701/111

(57) ABSTRACT

A knock waveform model (thick line) is prepared by correcting a line (thin line) representing an average value of a vibration waveform measured in advance to have more moderate inclination. The knocking determination device determines whether knocking occurred in an engine or not, based on a result of comparison between the knock waveform model and a waveform detected by a knock sensor.

This nonprovisional application is based on Japanese Patent Application No. 2005-126886 filed with the Japan Patent Office on Apr. 25, 2005, the entire contents of which are hereby incorporated by reference.

### BACKGROUND OF THE INVENTION

1. Field of the Invention

The present invention relates to a knocking determination device and, more specifically, to a knocking determination device for an internal combustion engine that determines whether knocking occurs or not, based on vibration waveform of the internal combustion engine.

2. Description of the Background Art

Conventionally, a technique for detecting knocking of an internal combustion engine is known. Japanese Patent Laying-Open No. 2001-227400 discloses a knock control device for an internal combustion engine that can accurately determine whether the engine knocks. The knock control device for an internal combustion engine includes a signal detector detecting a signal representing a waveform of vibration occurring in the internal combustion engine (or a vibration waveform signal), an occurrence period detector detecting a period as an occurrence period during which the vibration waveform signal detected by the signal detector assumes a predetermined value or higher, a peak position detector detecting a peak position in the occurrence period detected by the occurrence period detector, a knock determiner determining whether the internal combustion engine knocks based on the relation between the occurrence period and the peak position, and a knock controller controlling an operation state of the internal combustion engine in accordance with a determination result of the knock determiner. The knock determiner determines knock (knocking) occurs when the peak position relative to the occurrence period is in a predetermined range.

According to the knock control device for an internal combustion engine disclosed in the publication, a signal representing a waveform of vibration occurring in the internal combustion engine is detected by a signal detector. An occurrence period during which the vibration waveform signal assumes a predetermined value or higher and a peak position therein are detected by an occurrence period detector and a peak position detector, respectively. Thus, the knock determiner can determine whether the engine knocks by detecting the position of the peak in the occurrence period of the vibration waveform signal. According to the knock determination result, the operation state of the internal combustion engine is controlled. When the peak position relative to the occurrence period is in a predetermined range, that is, when a waveform has such a shape that the peak position appears earlier relative to a predetermined length of the occurrence period of the vibration waveform signal, the knock determiner recognizes it as being particular to knocking. Thus, even in a transition state where an operation state of the internal combustion engine abruptly changes or when electric loads are turned on/off, whether or not the internal combustion engine knocks is accurately determined, and the operation state of the internal combustion engine can be controlled appropriately.

However, while the engine knocks, a vibration that is greater in magnitude than a vibration attributed to knocking may sometimes be detected as noise. That is, in some cases a vibration attributed to a fault of a knock sensor or attributed to a vibration of the internal combustion engine itself may be greater in magnitude than a vibration attributed to knocking. In such cases, with the knock control device for an internal combustion engine of Japanese Patent Laying-Open No. 2001-227400, there has been a problem that the engine is erroneously determined as not knocking while the engine actually knocks, based on the fact that the peak position relative to the occurrence period is not within a predetermined range.

### SUMMARY OF THE INVENTION

An object of the present invention is to provide a knock determination device that can determine whether the engine knocks with high accuracy.

According to an aspect, the present invention provides a knocking determination device for determining knocking of an internal combustion engine. The knocking determination device includes: a crank angle detecting unit detecting a crank angle of the internal combustion engine; a storage unit storing a reference vibration waveform corrected to have more moderate inclination than a vibration waveform corresponding to knocking measured in advance between predetermined crank angles; and a determining unit determining whether knocking occurred in the internal combustion engine or not, based on a result of comparison between the detected waveform and the stored waveform.

According to the invention, the crank angle detecting unit detects the crank angle of the internal combustion engine, and the waveform detecting unit detects vibration waveform of the internal combustion engine between predetermined crank angles. The storage unit stores a reference vibration waveform corrected to have more moderate inclination than a vibration waveform corresponding to knocking measured in advance, between the predetermined crank angles. The determining unit determines, based on the result of comparison between the detected waveform and the stored waveform, whether the internal combustion engine knocks or not. By way of example, when the reference vibration waveform as the waveform of vibration when the engine knocks is prepared beforehand through an experiment or the like, the reference vibration waveform is adapted to have more moderate inclination than the vibration waveform corresponding to knocking measured in advance, and stored. Thus, it becomes possible to distinguish a knock from noise other than a knock. When the inclination when the vibration corresponding to knocking attenuates is compared with the inclination when vibration corresponding to the noise other than a knock attenuates, the vibration corresponding to the noise tends to have steeper inclination. Therefore, by preparing the reference vibration waveform adapted to have more moderate inclination than the vibration waveform corresponding to knocking measured in advance through an experiment or the like, it becomes possible to distinguish vibration corresponding to noise other than knocking from vibration corresponding to knocking, with high accuracy. Further, by storing the prepared reference vibration waveform and by comparing the reference vibration waveform with the detected waveform, occurrence of knocking can be determined. Therefore, whether or not the engine knocks can be determined based not only on the magnitude of vibration of the internal combustion engine but also on the crank angle at which vibration occurs. As a result, a knocking determination device that can accurately determine whether the knocking occurs or not can be provided.

According to another aspect, the present invention provides a knocking determination device for determining knocking of an internal combustion engine. The knocking determination device includes: a crank angle detecting unit detecting a crank angle of the internal combustion engine; a storage unit storing a vibration waveform corresponding to knocking measured in advance between predetermined crank angles; and a determining unit determining whether knocking occurred in the internal combustion engine or not, based on a result of comparison between the detected waveform and a reference vibration waveform corrected to have more moderate inclination than the stored vibration waveform.

According to the present invention, the crank angle detecting unit detects the crank angle of the internal combustion engine, and the waveform detecting unit detects vibration waveform of the internal combustion engine between predetermined crank angles. The storage unit stores a vibration waveform corresponding to knocking measured in advance, between the predetermined crank angles. The determining unit determines, based on the result of comparison between the detected waveform and a reference vibration waveform corrected to have more moderate inclination than the stored waveform, whether the internal combustion engine knocks or not. By way of example, the vibration waveform when the knocking occurs is stored through an experiment or the like. By comparing the detected waveform and a reference vibration waveform corrected to have more moderate inclination than the stored waveform, it becomes possible to distinguish a knock from noise other than a knock. When the inclination when the vibration corresponding to knocking attenuates is compared with the inclination when vibration corresponding to the noise other than a knock attenuates, the vibration corresponding to the noise tends to have steeper inclination. Therefore, by correcting the stored vibration waveform to have more moderate inclination than the vibration waveform corresponding to knocking measured in advance through an experiment or the like, it becomes possible to distinguish vibration corresponding to noise other than knocking from vibration corresponding to knocking, with high accuracy. Further, by comparing the reference vibration waveform with the detected waveform, occurrence of knocking can be determined. Therefore, whether or not the engine knocks can be determined based not only on the magnitude of vibration of the internal combustion engine but also on the crank angle at which vibration occurs. As a result, a knocking determination device that can accurately determine whether the knocking occurs or not can be provided.

Preferably, the reference vibration waveform is a vibration waveform corrected to have attenuation factor smaller than that of the measured vibration waveform.

According to the present invention, when the reference vibration waveform as the waveform of vibration when the internal combustion engine knocks is prepared beforehand through an experiment or the like, a vibration waveform corrected to have smaller attenuation factor than the vibration waveform corresponding knocking measured in advance is stored as the reference vibration waveform. This makes it possible to distinguish vibration corresponding to noise other than knocking from vibration corresponding to knocking. When the attenuation factor of vibration corresponding to knocking is compared with the attenuation factor of vibration corresponding to noise other than knocking between predetermined crank angles, the vibration corresponding to noise tends have larger attenuation factor. Therefore, by preparing the reference vibration waveform to have attenuation factor smaller than that of the vibration waveform corresponding to knocking measured in advance through an experiment or the like, it becomes possible to distinguish noise other than knocking from knocking, with high accuracy.

More preferably, the reference vibration waveform is a vibration waveform obtained by correcting the measured vibration waveform within a range of measurement error.

According to the present invention, when the reference vibration waveform as the waveform of vibration when the internal combustion engine knocks is prepared beforehand through an experiment or the like, a vibration waveform corrected to have more moderate inclination than that of the vibration waveform corresponding to knocking measured in advance is stored as the reference vibration waveform. Here, the inclination of the vibration waveform is corrected to be more moderate, within a range of measurement error. By such an approach, it becomes possible to accurately distinguish vibration corresponding to noise that attenuates steeply from vibration corresponding knocking that attenuates moderately, and to suppress degradation in precision of the reference vibration waveform.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration diagram showing an engine controlled by a knock determination device according to an embodiment of the present invention.

FIG. 2 is a diagram representing frequencies of vibrations occurring in the engine.

FIG. 3 is a diagram representing a knock waveform model stored in a memory of an engine ECU.

FIG. 4 represents a vibration waveform corresponding to knocking and a vibration waveform corresponding to noise other than knocking.

FIG. 5 represents a corrected knock waveform model (1).

FIG. 6 represents a corrected knock waveform model (2).

FIG. 7 is a flowchart illustrating a control structure of a program executed by the engine ECU.

FIG. 8 is a diagram representing a vibration waveform after normalization.

FIG. 9 is a diagram representing timings for comparing the normalized vibration waveform with the knock waveform model.

### DESCRIPTION OF THE PREFERRED EMBODIMENTS

Embodiments of the present invention will be described in the following with reference to the figures. In the following description, the same components are denoted by the same reference characters. The names and functions are also the same. Therefore, detailed description thereof will not be repeated.

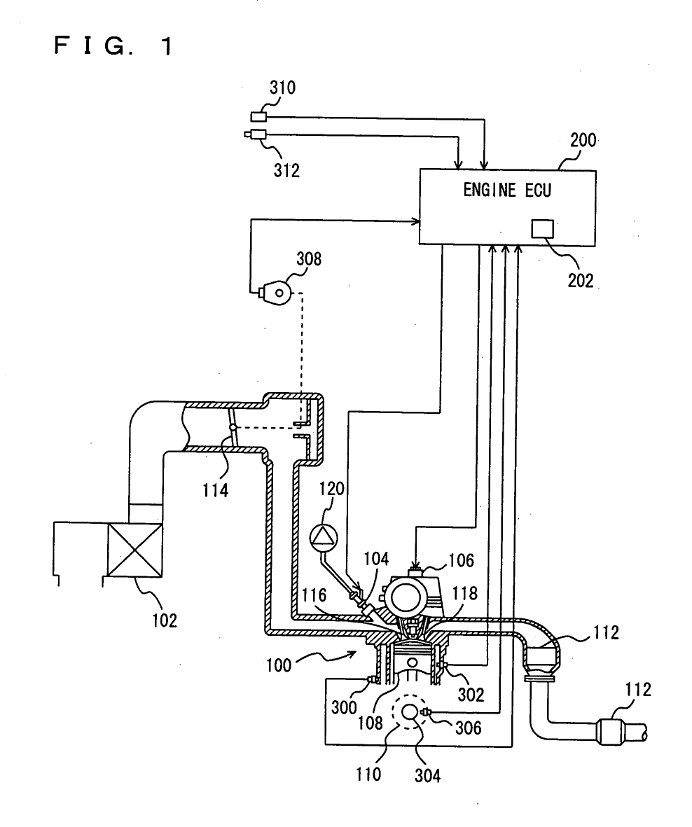

With reference to FIG. 1, an engine 100 of a vehicle incorporating a knock determination device according to an embodiment of the present invention will be described. The knock determination device of the present embodiment is implemented by a program executed, for example, by an engine ECU (Electronic Control Unit) 200.

Engine 100 is an internal combustion engine, in which a mixture of air taken through an air cleaner 102 and a fuel injected by an injector 104 is ignited by a spark plug 106 and burned in a combustion chamber.

The burning of air-fuel mixture causes combustion pressure that presses a piston 108 down, whereby a crank shaft 110 rotates. The combusted air-fuel mixture (or exhaust gas) is purified by a three-way catalyst 112 and thereafter discharged outside the vehicle. The amount of air taken into engine 100 is adjusted by a throttle valve 114.

Engine 100 is controlled by engine ECU 200 having connected thereto a knock sensor 300, a water temperature sensor 302, a crank position sensor 306 arranged opposite a timing rotor 304, a throttle opening sensor 308, a vehicle speed sensor 310, and an ignition switch 312.

Knock sensor 300 is implemented by a piezoelectric element. As engine 100 vibrates, knock sensor 300 generates a voltage having a magnitude corresponding to that of the vibration. Knock sensor 300 transmits a signal representing the voltage to engine ECU 200. Water temperature sensor 302 detects temperature of cooling water in engine 100 at a water jacket and transmits a signal representing a resultant detection to engine ECU 200.

Timing rotor 304 is provided at a crank shaft 110 and rotates as crank shaft 110 does. Timing rotor 304 is circumferentially provided with a plurality of protrusions spaced by a predetermined distance. Crank position sensor 306 is arranged opposite the protrusions of timing rotor 304. When timing rotor 304 rotates, an air gap between the protrusions of timing rotor 304 and crank position sensor 306 varies, so that magnetic flux passing through a coil portion of crank position sensor increases/decreases, thus generating electromotive force. Crank position sensor 306 transmits a signal representing the electromotive force to engine ECU 200. From the signal transmitted from crank position sensor 306, engine ECU 200 detects a crank angle.

Throttle opening sensor 308 detects a throttle open position and transmits a signal representing a resultant detection to engine ECU 200. Vehicle speed sensor 310 detects number of rotation of a wheel (not shown) and transmits a signal representing a resultant detection to engine ECU 200. From the number of rotation of the wheel, engine ECU 200 calculates the vehicle speed. Ignition switch 312 is turned on by a driver, for starting engine 100.

Engine ECU 200 uses the signals transmitted from each sensor and ignition switch 312 as well as a map and program stored in a memory 202 to perform an operation to control equipment so that engine 100 attains a desired driving condition.

In the present embodiment, using a signal transmitted from knock sensor 300 and a crank angle, engine ECU 200 detects a waveform of a vibration of engine 100 at a predetermined knock detection gate (a section from a predetermined first crank angle to a predetermined second crank angle) (hereinafter such waveform of a vibration will also simply be referred to as “vibration waveform”) and from the detected vibration waveform determines whether engine 100 knocks. The knock detection gate of the present embodiment is from the top dead center (0°) to 90° in a combustion stroke. It is noted that the knock detection gate is not limited thereto.

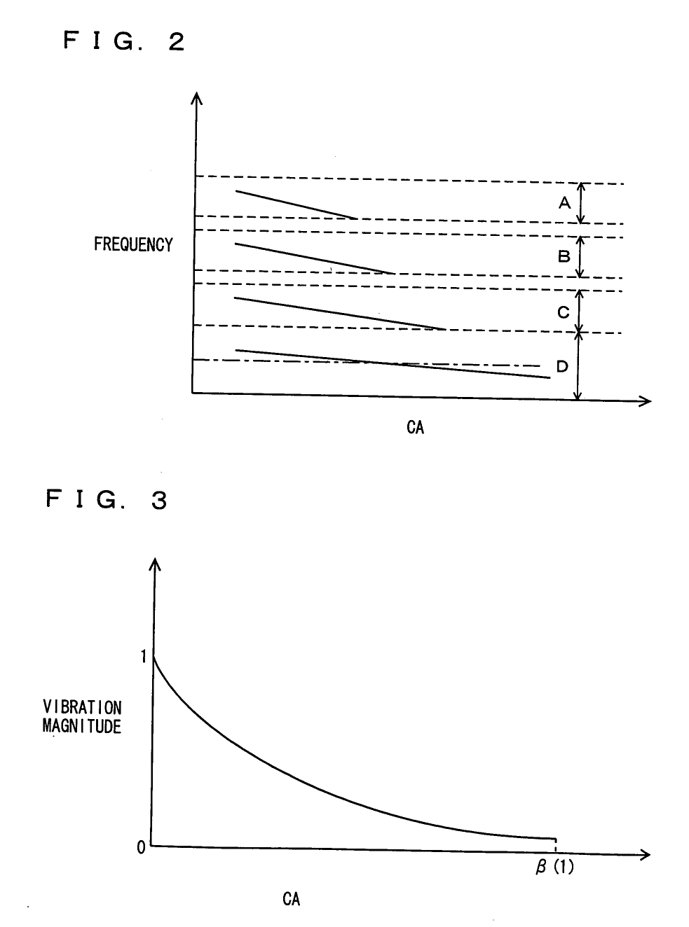

When the engine knocks, vibrations occur in engine 100 at frequencies around the frequencies represented by solid lines in FIG. 2. That is, when engine 100 knocks, the vibrations at frequencies included in a first frequency band A, a second frequency band B, a third frequency band C, and a fourth frequency band D occur. In FIG. 2, CA represents a crank angle. The number of frequency bands including the frequencies of a vibration attributed to knocking is not limited to four.

Of these frequency bands, fourth frequency band D includes a resonance frequency of engine 100 itself that is represented by an alternate-short-and-long dashed line in FIG. 2. Vibration of resonance frequency generates regardless of presence/absence of knocking.

Therefore, in the present embodiment, a vibration waveform is detected based on the magnitudes of the vibrations of first to third frequency bands A to C not including the resonance frequency. The number of frequency bands used in detecting the vibration waveform is not limited to three. The detected vibration waveform is compared with a knock waveform model, which will be described later.

In order to determine whether a knock occurred or not, a memory 202 of engine ECU 200 stores a knock waveform model, which is a model vibration waveform when engine 100 knocks, as shown in FIG. 3.

In the knock waveform model, magnitude of vibration is represented by a dimensionless number of 0 to 1 and does not uniquely correspond to a crank angle. More specifically, for the knock waveform model of the present embodiment, while it is determined that the vibration decreases in magnitude as the crank angle increases after the peak value in magnitude of vibration, the crank angle at which the vibration magnitude assumes the peak value is not determined. In the present embodiment, the knock waveform model is stored in memory 202 with the crank angle at which the vibration magnitude peaks being set to zero. Here, the knock waveform model to a predetermined angle β(1) is stored in memory 202. The predetermined angle β(1) is not specifically limited, as long as it corresponds to the angle from the angle corresponding to the peak of the detected waveform to the angle at the terminal end of the knock detection gate, at the time of comparison with the waveform detected by knock sensor 300. Furthermore, the knock waveform model is a synthesized wave of vibrations of first to third frequency bands A to C.

The knock waveform model of the present embodiment corresponds to the vibration after the peak magnitude of vibration generated by knocking. A knock waveform model that corresponds to vibration after the rise of vibration caused by knocking may be stored.

The knock waveform model is obtained as follows: an experiment or the like is conducted to force knocking of engine 100, and the vibration waveform of engine 100 is detected, from which the knock waveform model is created and stored in advance. It should be noted, however, that the models might be created by a different method. Engine ECU 200 compares a detected waveform with the stored knock waveform model to determine whether engine 100 knocks.

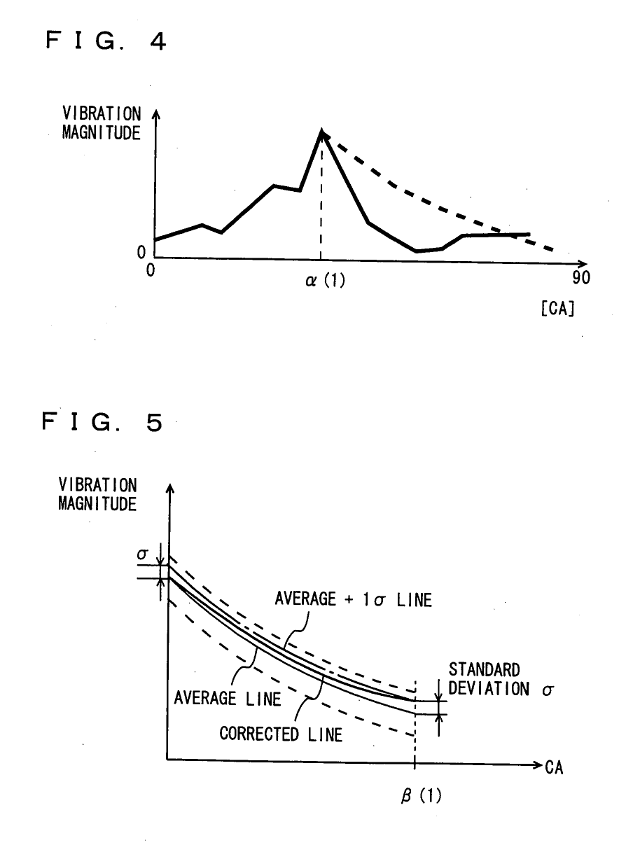

As shown in FIG. 4, waveform of vibration (solid line) caused by the operation of engine 100 other than knocking tends to have steeper inclination than the vibration (dotted line) corresponding to knocking. The vibration caused by the operation of engine 100 other than knocking may include, by way of example, vibration generated when an intake valve 116 or exhaust valve 118 closes and comes to contact with an intake port or an exhaust port, that is, vibration caused when intake valve 116 or exhaust valve 118 is seated, and vibration caused by an operation of injector 104.

The present invention is characterized in that when the knock waveform model is formed within a predetermined crank angle from the top dead center to 90°, the vibration waveform corresponding to knocking measured in advance is corrected to have more moderate inclination and stored, and based on the result of comparison between the stored knock waveform model and the vibration waveform detected by knock sensor 300, whether engine 100 knocks or not is determined.

Specifically, to form the knock waveform model, by an experiment or the like, a knock is intentionally caused and the vibration waveform of engine 100 is detected. At this time, the vibration waveforms obtained by a number of experiments converge within the area surrounded by the dotted line in FIG. 5. In the present embodiment, a line (thick line) corrected to have more moderate inclination than the line (thin line) representing an average of the obtained vibration waveforms is adopted as the knock waveform model.

The knock waveform model is not specifically limited, as long as it is corrected to a line that is more moderate than the line representing the average value of obtained vibration waveforms. Preferably, however, the knock waveform model should be formed, as regards the vibration waveform after the peak to the angle β(1), by correcting the vibration waveform to be within the area between the average line and the line of average +1σ (alternate short-and-long line) on the side of larger vibration by standard deviation 1σ than the average line as shown in FIG. 5.

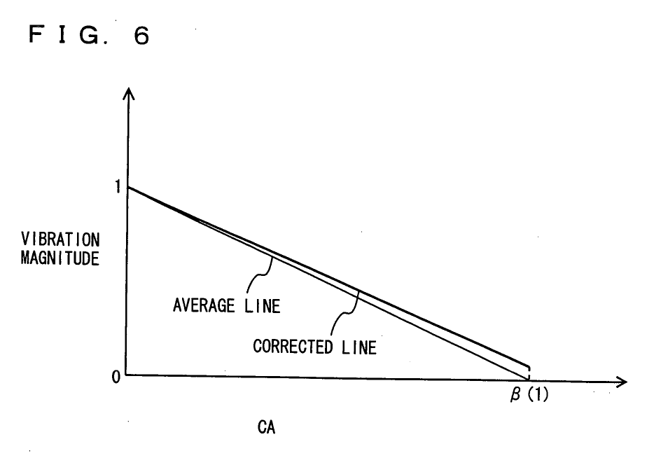

Further, the knock waveform model is not specifically limited to the shape shown in FIG. 3, and it may be a knock waveform model that linearly attenuates, such as shown in FIG. 6. In that case, the line (thick line) corrected to have more moderate inclination than the average line (thin line) may be used as the knock waveform model, as described above. Specifically, a line corrected to have smaller attenuation factor than that of the average line may be used as the knock waveform model. The attenuation factor of the average line refers to the absolute value of the rate of change (inclination) from the peak of the average line. By making the attenuation factor smaller than that of the average line, the knock waveform model can be formed to have more moderate inclination than the average line.

Preferably, the knock waveform model should be corrected within the range of error of a sensor (such as a knock sensor) used for measuring the vibration waveform in the experiment. Further, the knock waveform model is normalized by dividing the corrected line by the maximum value (peak vibration magnitude at the crank angle of zero) of the corrected line, and stored in memory 202. Thus, the vibration magnitude of knock waveform model comes to be represented as dimensionless value of 0 to 1.

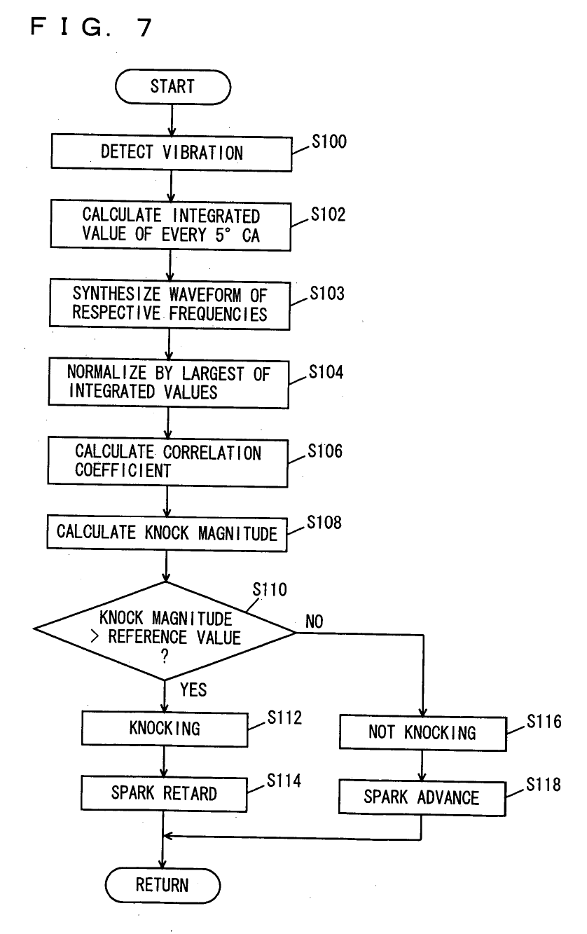

Referring to FIG. 7, the control structure of the program executed by engine ECU 200 in the knocking determination device in accordance with the present embodiment will be described.

At step (hereinafter simply referred to as “S”) 100, engine ECU 200 detects the vibration magnitude of engine 100 from a signal transmitted from knock sensor 300. The vibration magnitude is represented by a value of voltage output from knock sensor 300. Note that the vibration magnitude may be represented by a value corresponding to the value of the voltage output from knock sensor 300. The vibration magnitude is detected in a combustion stroke for an angle from a top dead center to (a crank angle of) 90°.

At S102, engine ECU 200 calculates for a crank angle of every five degrees an integration (hereinafter also be referred to as an “integrated value”) of values of voltage output from knock sensor 300 (i.e., representing magnitude of vibration). The integrated values are calculated for the vibration of each of the first to third frequency bands A to C.

At S103, engine ECU 200 synthesizes the vibration waveforms of respective frequency bands. Specifically, from the calculated integrated values, integrated values of vibration in the first to third frequency bands A to C are synthesized. Thus, the vibration waveform of engine 100 is detected.

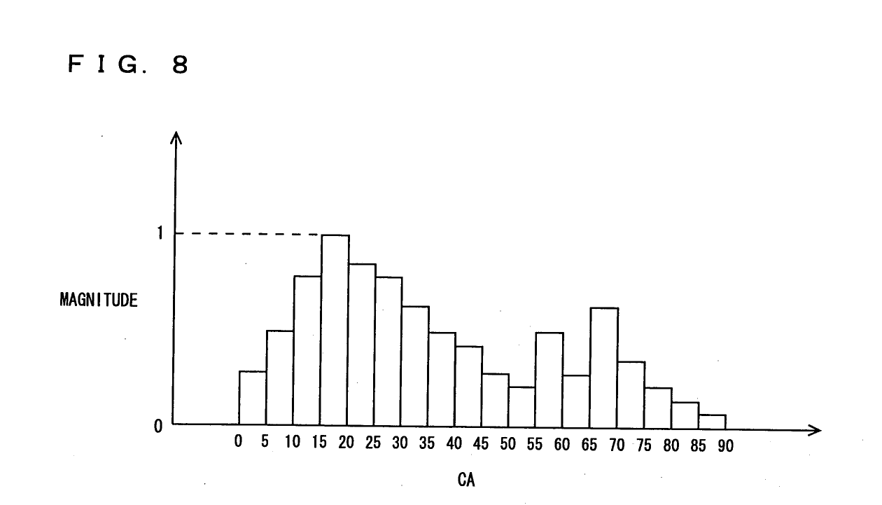

At S104, engine ECU 200 normalizes the waveform using the largest of the integrated values of the synthesized vibration waveform. Here, normalizing a waveform means dividing each integrated value by the largest of the integrated values in the detected waveform, for example, so that the vibration magnitude is represented by a dimensionless number of 0 to 1, as shown in FIG. 8. The divisor of each integrated value is not limited to the largest of the integrated values.

Returning to FIG. 7, at S106, engine ECU 200 calculates a coefficient of correlation K, which is a value related to a deviation between the normalized vibration waveform and the knock waveform model. A timing of a normalized vibration waveform providing a vibration maximized in magnitude and a timing of a knock waveform model providing a vibration maximized in magnitude are matched, while a deviation in absolute value (or an amount of offset) between the normalized vibration waveform and the knock waveform model is calculated for each crank angle (of five degrees), whereby the coefficient of correlation K is obtained.

When we represent the absolute value of deviation between the normalized vibration waveform and the knock waveform model for each crank angle by ΔS(I) (wherein I is a natural number) and the vibration magnitude of knock waveform model integrated by the crank angle (i.e., the area of knock waveform model) by S, then the coefficient of correlation K is calculated by an equation K=(S−ΣΔS(I))/S, where ΣΔS (I) represents a sum of ΔS(I)s for the top dead center to 90°. Note that the coefficient of correlation K may be calculated by a different method.

At S108, engine ECU 200 calculates a knock intensity N. When we represent the maximum value of calculated integrated value by P and the value representing the magnitude of vibration of engine 100 while engine 100 is not knocking by BGL (Back Ground Level), the nock intensity N is calculated by the equation N=P×K/BGL. The BGL is stored in memory 202. Note that knock intensity N may, be calculated by a different method.

At S110, engine ECU 200 determines whether knock intensity N is larger than a predetermined reference value. If the knock intensity N is larger than the predetermined reference value (YES at S110), the control proceeds to S112. Otherwise (NO at S110), the control proceeds to S116.

At S112, engine ECU 200 determines that engine 100 knocks. At S114 engine ECU 200 introduces a spark retard. At S116 engine ECU 200 determines that engine 100 does not knock. At S118 engine ECU 200 introduces a spark advance.

An operation of engine ECU 200 of the knock determination device according to the present embodiment based on the above-described configuration and flowchart will be described.

When a driver turns on ignition switch 312 and engine 100 starts, vibration magnitude of engine 100 is detected from a signal transmitted from knock sensor 300 (S100).

In a combustion stroke for a range from the top dead center to 90°, an integrated value for every five degrees is calculated for respective vibrations of each of the first to the third frequency bands A to C (S102). Then, of the calculated integrated values, integrated values of vibrations in the first to third frequencies A to C are synthesized together (S103). Thus, as shown in FIG. 8, the vibration waveform of engine 100 is detected as a synthesized wave of vibrations of the first to third frequency bands A to C.

Note that while FIG. 8 represents a vibration waveform in rectangles, each integrated value may be connected by a line to represent the vibration waveform. Furthermore, each integrated value alone may be represented in a dot to represent the vibration waveform.

As an integrated value for every five degrees is used to detect a vibration waveform, it becomes possible to detect a vibration waveform of which delicate variations are suppressed. This makes it easier to compare a detected vibration waveform with the knock waveform model.

Of the integrated values of vibration waveforms thus detected, the maximum integrated value is used to normalize the waveform (S104). Here, it is assumed that each integrated value is divided by the integrated value for 15° to 20° to normalize the vibration waveform. By the normalization, vibration magnitude in the vibration waveform is represented by a dimensionless number of 0 to 1. Thus, the detected vibration waveform can be compared with the knock waveform model regardless of the vibration magnitude. This can eliminate the necessity of storing a large number of knock waveform models corresponding to the magnitude of vibration and thus, facilitates preparation of the knock waveform model.

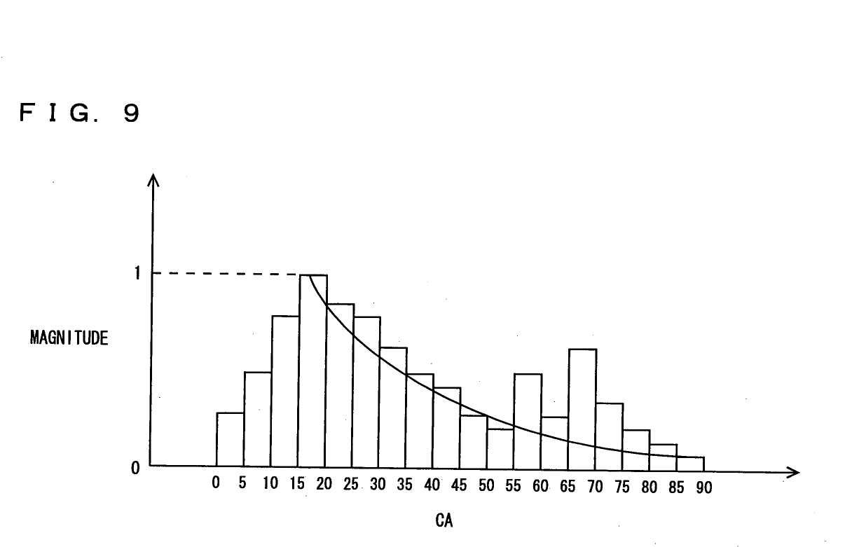

As shown in FIG. 9, a timing of a normalized vibration waveform providing a vibration maximized in magnitude and that of a knock waveform model providing a vibration maximized in magnitude are matched, while a deviation in absolute value ΔS (I) between the normalized vibration waveform and the knock waveform model is calculated for each crank angle.

Sum ΣΔS (I) of such ΔS(I) and value S representing a magnitude of vibration in knock waveform model that is integrated by crank angle are used to calculate the coefficient of correlation K=(S−ΣΔS(I))/S (S106). This allows numerical representation of a degree of matching between the detected vibration waveform and the knock waveform model, and hence allows objective determination.

Here, the knock waveform model is corrected to have more moderate inclination than the vibration waveform measured in advance, and therefore, when vibration corresponding to noise caused by an operation of engine 100 is detected, coefficient of correlation K tends to degrade. Therefore, it becomes possible to distinguish a vibration corresponding to noise from a vibration corresponding to knocking, with high accuracy.

The product of the calculated coefficient of correlation K and the largest integrated value P is divided by the BGL to calculate knock intensity N (S108). Thus, whether the vibration of engine 100 is attributed to knocking can be analyzed in greater detail, using vibration magnitude in addition to the degree of matching between the detected vibration waveform and the knock waveform model. Here, it is assumed that the product of coefficient of correlation K and the integrated value for 15°-20° is divided by BGL to calculate knock intensity N.

If knock intensity N is larger than a predetermined reference value (YES at S110) a determination is made that engine knocks (S112), and a spark retard is introduced (S114) to suppress knocking.

If knock intensity N is not larger than the predetermined reference value (NO at S110), a determination is made that the engine does not knock (S116), and a spark advance is introduced (S118).

As described above, by the knocking determining device in accordance with the present embodiment, as the knock waveform model is prepared to have more moderate inclination than the vibration waveform corresponding to knocking measured in advance through an experiment or the like, it becomes possible to distinguish a vibration corresponding to noise other than knocking from a vibration corresponding to knocking, with higher accuracy. Further, the prepared knock waveform model is stored and the knock waveform model and the waveform detected by the knock sensor are compared with each other to determine whether knocking has occurred or not. Therefore, occurrence of a knock can be determined based not only on the magnitude of engine vibration but also on the crank angle at which the vibration occurs. Thus, a knocking determination device that can determine occurrence of a knock with high accuracy can be provided.

Further, the stored knock waveform model is obtained by correcting the measured vibration waveform within the range of measurement error. Therefore, it is possible to distinguish a vibration corresponding to noise that attenuates steeply from a vibration corresponding to knocking that attenuates moderately with high accuracy, and to prevent degradation in precision of the knock waveform model.

Further, in the description above, the knock waveform model prepared to have more moderate inclination than the vibration waveform corresponding to knocking measured in advance is stored. This is not limiting and, by way of example, the vibration waveform corresponding to knocking measured in advance may be stored as the knock waveform model, and when determination is made as to whether knocking occurred or not, the waveform detected by the knock sensor may be compared with a knock waveform model that is corrected to have more moderate inclination than the stored knock waveform model, to determine whether a knock has occurred or not. This approach also allows highly accurate determination of knock generation.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A knocking determination device for an internal combustion engine, comprising:
a crank angle detecting unit detecting a crank angle of said internal combustion engine;
a storage unit storing a reference vibration waveform corrected to have more moderate inclination than a vibration waveform corresponding to knocking measured in advance between predetermined crank angles; and
a determining unit determining whether knocking occurred in said internal combustion engine or not, based on a result of comparison between said detected waveform and said stored waveform.

2. The knocking determination device according to claim 1, wherein
said reference vibration waveform is a vibration waveform corrected to have attenuation factor smaller than that of said measured vibration waveform.

3. A knocking determination device for an internal combustion engine, comprising:
a crank angle detecting unit detecting a crank angle of said internal combustion engine;
a storage unit storing a vibration waveform corresponding to knocking measured in advance between predetermined crank angles; and
a determining unit determining whether knocking occurred in said internal combustion engine or not, based on a result of comparison between said detected waveform and a reference vibration waveform corrected to have more moderate inclination than said stored vibration waveform.

4. The knocking determination device according to claim 3, wherein
said reference vibration waveform is a vibration waveform corrected to have attenuation factor smaller than that of said measured vibration waveform.

5. The knocking determination device according to any of claims 1 to 4, wherein
said reference vibration waveform is a vibration waveform obtained by correcting said measured vibration waveform within a range of measurement error.

6. A knocking determination device for an internal combustion engine, comprising:
crank angle detecting means for detecting a crank angle of said internal combustion engine;
storage means for storing a reference vibration waveform corrected to have more moderate inclination than a vibration waveform corresponding to knocking measured in advance between predetermined crank angles; and
determining means for determining whether knocking occurred in said internal combustion engine or not, based on a result of comparison between said detected waveform and said stored waveform.

7. The knocking determination device according to claim 6, wherein
said reference vibration waveform is a vibration waveform corrected to have attenuation factor smaller than that of said measured vibration waveform.

8. A knocking determination device for an internal combustion engine, comprising:
crank angle detecting means for detecting a crank angle of said internal combustion engine;
storage means for storing a vibration waveform corresponding to knocking measured in advance between predetermined crank angles; and
determining means for determining whether knocking occurred in said internal combustion engine or not, based on a result of comparison between said detected waveform and a reference vibration waveform corrected to have more moderate inclination than said stored vibration waveform.

9. The knocking determination device according to claim 8, wherein
said reference vibration waveform is a vibration waveform corrected to have attenuation factor smaller than that of said measured vibration waveform.

10. The knocking determination device according to any of claims 6 to 9, wherein
said reference vibration waveform is a vibration waveform obtained by correcting said measured vibration waveform within a range of measurement error.
